(19) United States
(12) Patent Application Publication
(10) Pub. No.: US 2009/0236900 A1
(43) Pub. Date: Sep. 24, 2009

(54) DUST AND DEBRIS EVACUATOR FOR CUT-OFF SAW

(76) Inventors: Joseph Eugene Due, Mauston, WI (US); Benjamin Francis Due, Mauston, WI (US); Bradley Gardner Due, Portage, WI (US)

Correspondence Address: MERCHANT & GOULD PC, P.O. BOX 2903, MINNEAPOLIS, MN, 55402-0903, US

(21) Appl. No.: 12/355,399

(22) Filed: Jan. 16, 2009

Related U.S. Application Data
(60) Provisional application No. 61/022,150, filed on Jan. 19, 2008.

(51) Int. Cl. B28D 7/02; B28D 1/04; B23D 59/00

(52) U.S. Cl. 299/39.3; 125/13.01

(57) ABSTRACT

A dust and debris evacuator is provided for a cut-off saw. The cut-off saw having a rapidly rotating disk-shaped cutting blade for cutting material and thereby producing and ejecting the dust and debris. The evacuator having a channel to receive the ejected dust and debris, and the channel having a front opening facing the cutting blade. A vacuum cleaner is preferably connected to the evacuator to clear the dust and debris from the channel. In a preferred embodiment, the cut-off saw is pivotally mounted to the evacuator.

### CROSS REFERENCE TO RELATED APPLICATION

This application claims the benefit of U.S. Provisional Patent Application Ser. No. 61/022,150, filed Jan. 19, 2008, which application is hereby incorporated by reference in its entirety.

### TECHNICAL FIELD

The present disclosure relates to dust and debris collection and removal from cutting operations performed by cutting tools.

### BACKGROUND

Cut-off saws are widely used in construction industries for cutting through existing structures and materials. Concrete and asphalt floors, roadways, and parking lots are examples of such structures that are modified from time to time by cutting operations. The typical cut-off saw includes a thin disk-shaped rotating saw blade with a perimeter featuring hard cutting surfaces. An internal combustion engine typically powers the rotating saw blade, spinning the blade at high speeds about a rotational axis. As the hard rotating cutting surfaces engage the material to be cut at a cutting location, the material is physically ground and/or pulverized and transformed into dust and/or debris thus eroding the material. The cut-off saw is typically driven into the material perpendicular to the rotational axis of the saw blade. The saw blade thus engages the material along its perimeter at the cutting location and erodes a thin cut along a path that the cut-off saw is driven. The eroded dust and debris typically are ejected by the cut-off saw blade at high speeds and can travel a considerable distance before coming to rest. Much of the dust created by the cut-off saw is fine and forms a dust cloud in surrounding air. Furthermore, the dust cloud is suspended by the air for a considerable amount of time and can drift with air currents before settling. The dust may contaminate a wide indoor and/or outdoor area as it settles.

In most applications, the cut-off saw leaves material adjacent the cut intact and undamaged making the cut-off saw suitable in remodeling projects. Remodeling projects often require removal of material, such as portions of concrete floors, within an existing building. The dust and debris generated by the cut-off saw contaminates the building interior and typically requires clean-up. In many cases, the dust and debris clean-up can take more time to accomplish than the cutting process.

The dust generated by the cut-off saw also contaminates close running surfaces of the cut-off saw and eventually plugs an air filter of the internal combustion engine powering the saw. Concrete dust is particularly abrasive and accelerates wear on the close running surfaces of the cut-off saw. In addition, an operator of the cut-off saw is exposed to the dust and can inhale the dust. Furthermore, the dust may irritate the operator's eyes and may reduce the operator's visibility. Eye protection, and dust masks can be worn by the operator but also can become covered in dust.

Injecting water at the cutting location can capture the dust and thus reduce or eliminate airborne dust. The captured dust and water form a slurry which typically must be collected and cleaned-up. The slurry can coat and contaminate a large area and flows downhill and into the cut. In many cases, cleaning the slurry can take more time to accomplish than the cutting process.

There is a need for a dust collecting device to effectively and conveniently collect dust and debris created by the operation of cut-off saws. The present disclosure satisfies these and other needs.

### SUMMARY

One aspect of the present disclosure relates to a dust and debris evacuator for collecting dust and debris created while operating a cut-off saw. In a preferred embodiment, the evacuator is adaptable for pivotally mounting various cut-off saws produced by a number of manufactures. A vacuum cleaner is preferably attached via a vacuum hose to a vacuum port on the evacuator to continuously remove the dust and debris collected by the evacuator.

Upon selecting a particular cut-off saw and vacuum cleaner for use with the evacuator, an adaptor bracket is selected and installed that matches the cut-off saw and a vacuum port adapter is selected that matches the vacuum cleaner or the vacuum hose. In a preferred embodiment, the adaptor bracket is integrated with a pivot mount that is configured to pivotally mount the particular cut-off saw to the evacuator.

In a preferred embodiment, the cut-off saw includes a saw blade that rotates downwardly through material being cut. As mentioned above, the saw blade grinds and/or pulverizes the material at high speed and ejects the material rearward as dust and/or fine debris. The evacuator is positioned behind the saw blade and includes a channel with a forward opening at a first end configured to capture and collect the ejected material. The channel is downwardly open over the material being cut and is connected to a passage of the vacuum port. The ejected material typically strikes the channel and thereby looses momentum. Suction created by the vacuum cleaner creates airflow along the channel which entrains the dust and debris. The entrained dust and debris follow the airflow through the passage of the vacuum port and into the vacuum hose and the vacuum cleaner. The dust and debris can be collected and accumulated in the vacuum cleaner and disposed of.

In a preferred embodiment, the cut-off saw further includes a blade guard covering an upper portion of the saw blade and the evacuator includes a blade guard surround for closely surrounding a rear portion of the blade guard.

A variety of additional aspects will be set forth in the description that follows. The aspects can relate to individual features and to combinations of features. It is to be understood that both the forgoing general description and the following detailed description are exemplary and explanatory only and are not restrictive of the broad concepts upon which the embodiments disclosed herein are based.

### BRIEF DESCRIPTION OF THE DRAWINGS

FIG. 1 is a left elevation view of a cut-off saw assembled to a dust evacuator, the cut-off saw including a saw blade raised above a concrete slab;

FIG. 2 is a left elevation view of the cut-off saw and the dust evacuator of FIG. 1, the cut-off saw rotatably positioned such that the saw blade tangentially contacts the concrete slab;

FIG. 3 is a right elevation view of the cut-off saw and the dust evacuator of FIG. 1, the cut-off saw rotatably positioned such that the saw blade penetrates the concrete slab;

FIG. 4 is a left elevation view of the cut-off saw and the dust evacuator of FIG. 1, the cut-off saw rotatably positioned such that the saw blade penetrates the concrete slab to a greater depth than that of FIG. 3;

FIG. 5 is a left and top perspective view of the cut-off saw and the dust evacuator of FIG. 1, the dust evacuator connected to a vacuum cleaner by a vacuum port adapter and a vacuum hose, the cut-off saw rotatably positioned such that the saw blade penetrates the concrete slab;

FIG. 6 is a left and front perspective view of the cut-off saw and the dust evacuator of FIG. 1, the cut-off saw rotatably positioned such that the saw blade penetrates the concrete slab;

FIG. 7 is a left, front, and top perspective view of the cut-off saw and the dust evacuator of FIG. 1, the cut-off saw including a blade guard and the dust evacuator including a blade guard surround closely surrounding the blade guard;

FIG. 8 is a front elevation view of the cut-off saw and the dust evacuator of FIG. 1, the cut-off saw rotatably positioned as in FIG. 2;

FIG. 9 is a rear elevation view of the cut-off saw and the dust evacuator of FIG. 1, the cut-off saw rotatably positioned as in FIG. 4;

FIG. 10 is a front elevation view of the cut-off saw and the dust evacuator of FIG. 1, the cut-off saw rotatably positioned such that the evacuator is angled upward as the saw blade contacts the concrete slab;

FIG. 11 is a left, rear, and top perspective view of the dust evacuator of FIG. 1;

FIG. 12 is a right, front, and bottom perspective view of the dust evacuator of FIG. 1;

FIG. 13 is a top plan view of the dust evacuator of FIG. 1;

FIG. 14 is a bottom plan view of the dust evacuator of FIG. 1;

FIG. 15 is a left elevation view of the dust evacuator of FIG. 1 further including a vacuum port adapter;

FIG. 16 is a front elevation view of the dust evacuator of FIG. 1;

FIG. 17 is a rear elevation view of the dust evacuator of FIG. 1;

FIG. 18 is an exploded left, rear, and top perspective view of the dust evacuator of FIG. 1 illustrating a detail of a cut-off saw adapter integrated with a mounting bracket for the cut-off saw;

FIG. 19 is a partially exploded right, rear, and bottom perspective view of the dust evacuator of FIG. 1;

FIG. 20 is a front and bottom perspective view of the dust evacuator of FIG. 1 further including a pair of evacuator side shields;

FIG. 21 is a left elevation view of the dust evacuator of FIG. 1 further including the pair of evacuator side shields of FIG. 20;

FIG. 22 is a left elevation view of the dust evacuator of FIG. 1 further including the pair of evacuator side shields of FIG. 20, the dust evacuator angled upward as in FIG. 10 and the side shields remaining in contact with the concrete slab;

FIG. 23 is a left elevation view of a dust evacuator including four wheels connected to a frame; and

FIG. 24 is a perspective view of another cut-off saw adapter integrated with another mounting bracket for the cut-off saw.

### DETAILED DESCRIPTION

The present disclosure relates to cut-off saws and collecting and containing dust and debris created in their operation. As mentioned above, the dust and debris contaminate a large area around the cut-off saw and may form a dust cloud and thereby further contaminate other areas where the dust cloud is carried. In addition, the dust and debris are harmful to the cut-off saw and to its operator and may reduce the visibility of the operator. Collecting and containing the dust and debris largely reduces or eliminates these problems thus providing economic benefits.

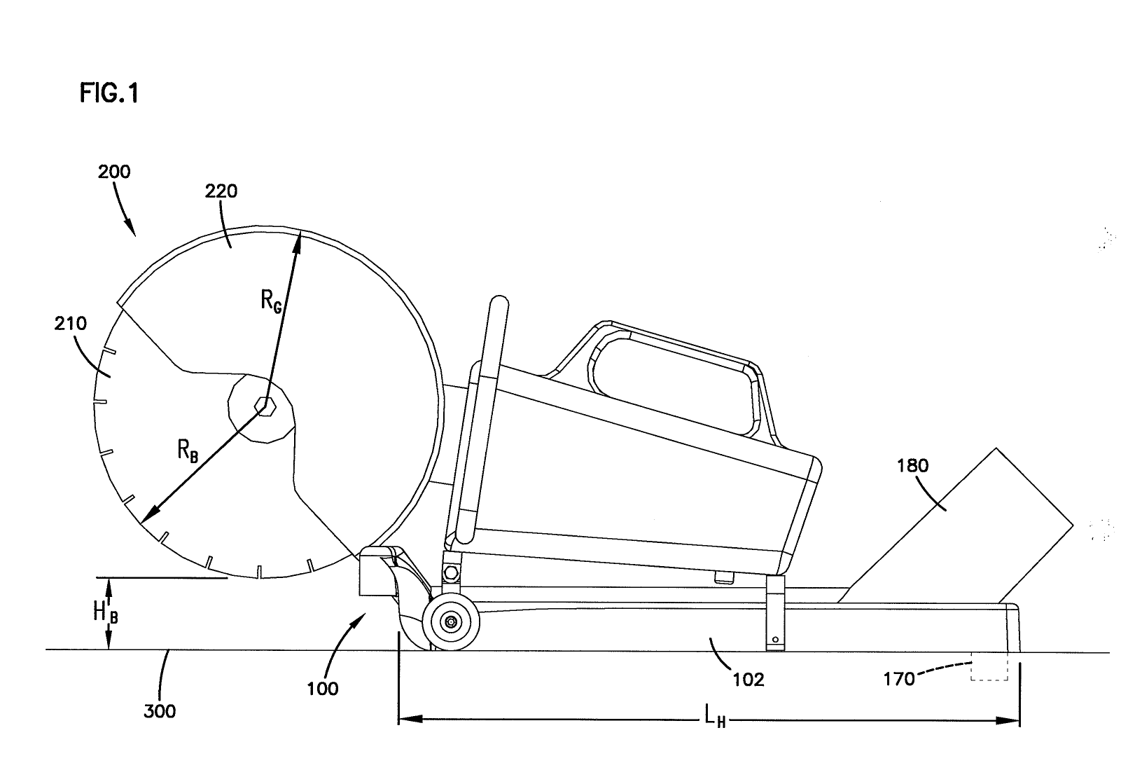

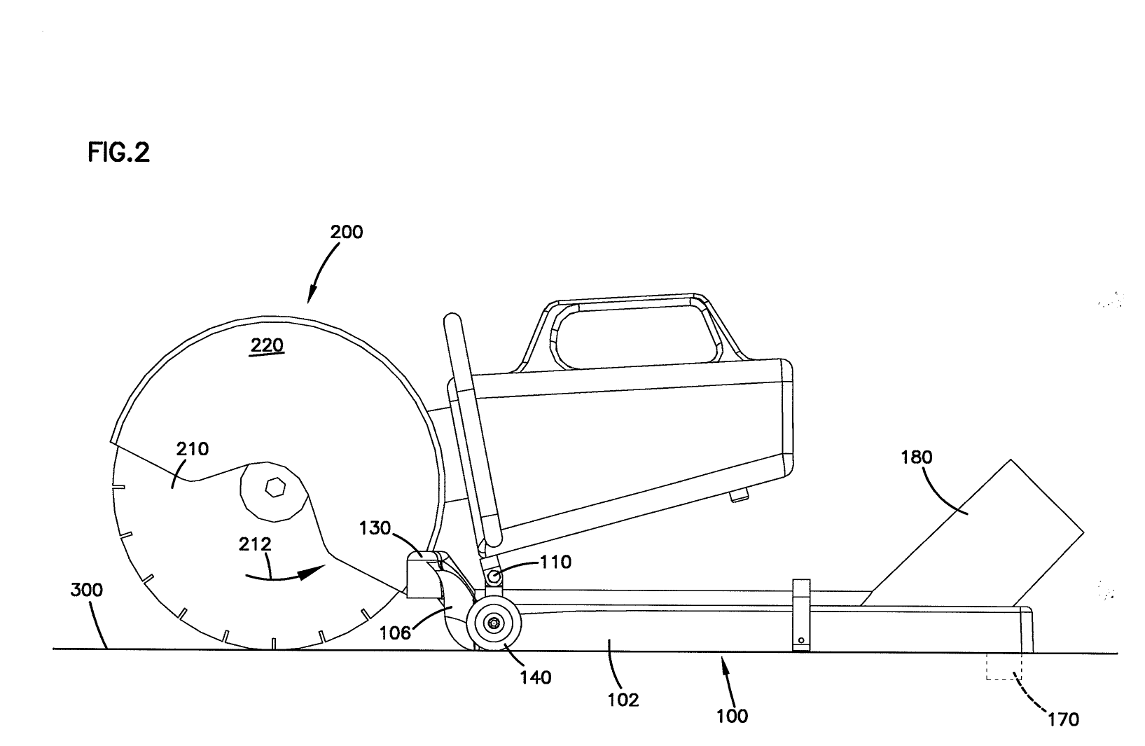

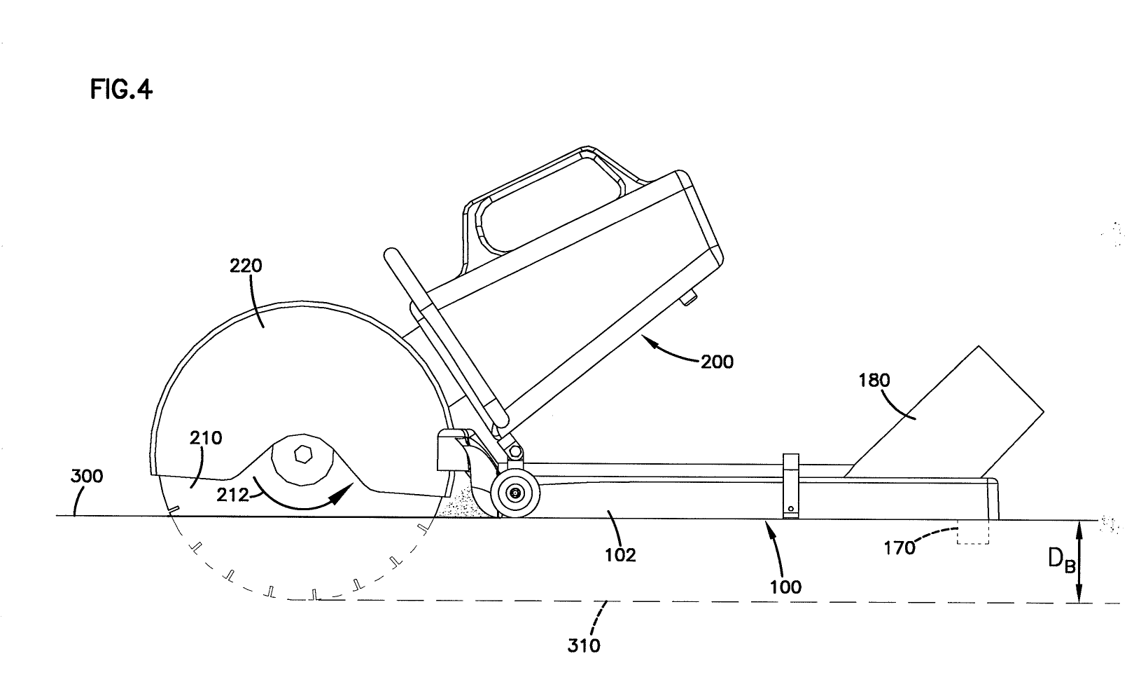

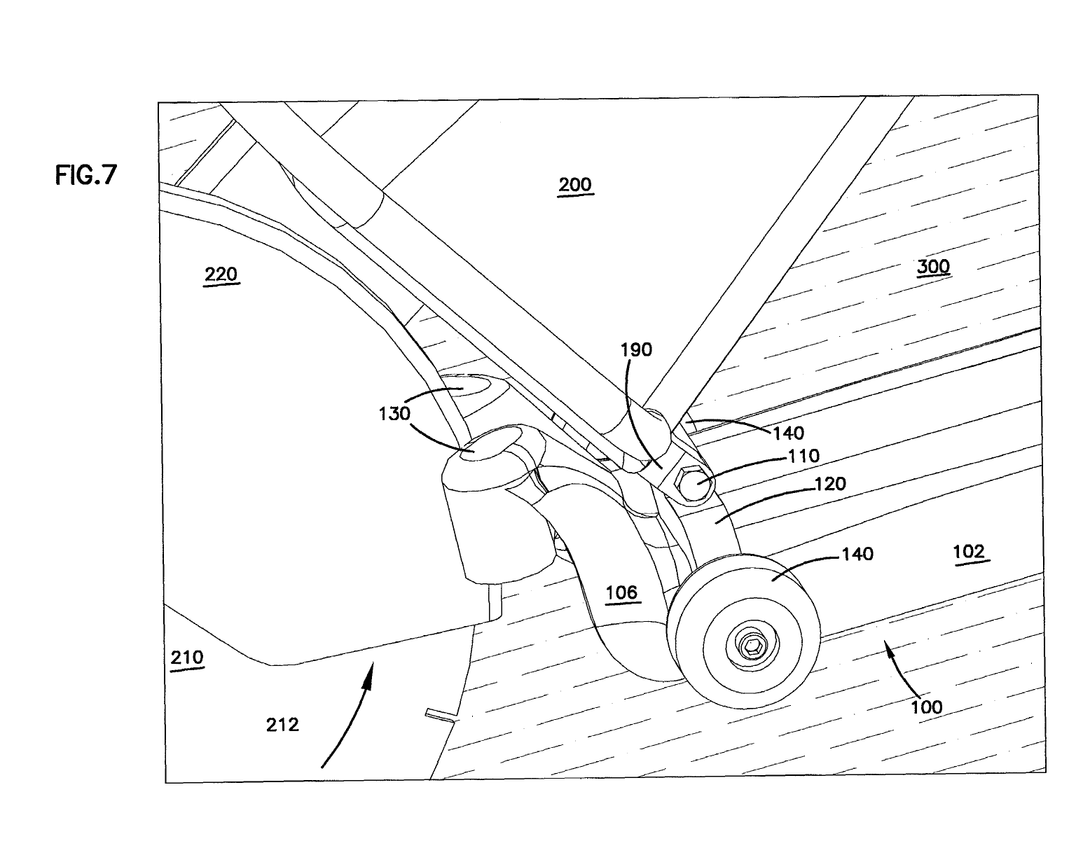

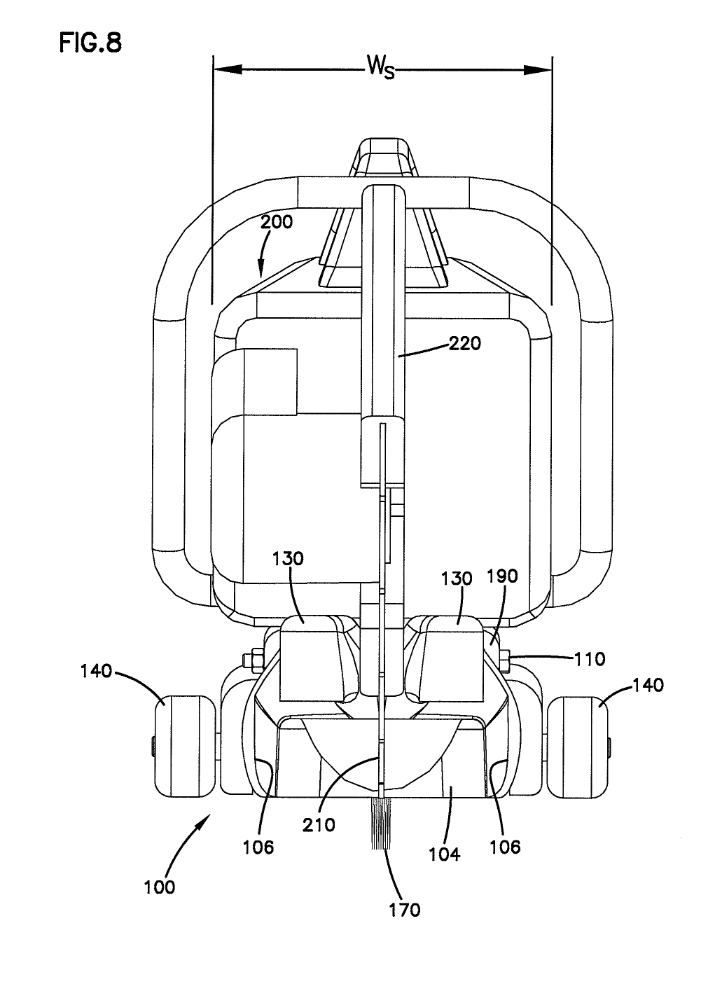

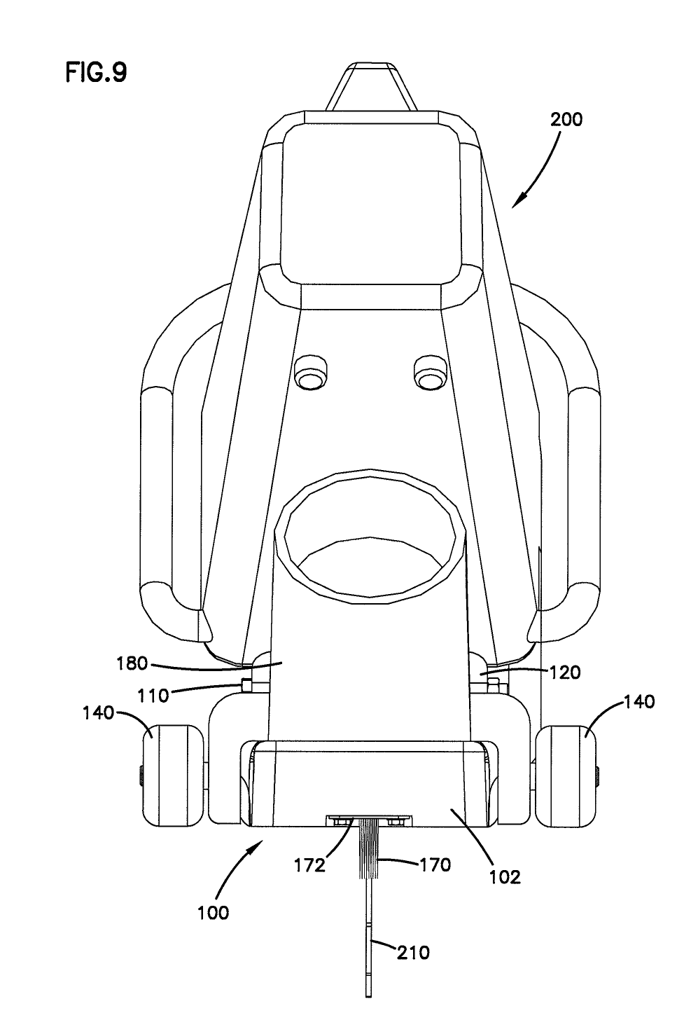

An example cut-off saw 200 is illustrated at FIGS. 1-10 and generally described above. Other example cut-off saws include models K 650, K 700, K750, K 950, K 960, and K1250 manufactured by Husqvarna of Olathe, Kans.; models DPC 6400, DPC 6401, DPC 6410, DPC 6411, DPC 7300, DPC 7301, DPC 7310, DPC 7311, and DPC 8112 manufactured by Makita of LaMirada, Calif.; models TS 400, TS 410, TS 420, TS 460, TS 700, TS 760, TS 800, and TS 860 manufactured by Stihl of Virginia Beach, Va.; and models BTS 930L3, BTS 935L3, BTS 1030L3, and BTS 1035L3 manufactured by Wacker of Menomonee Falls, Wis. The example cut-off saw 200 at FIGS. 1-10 is known as a down-cutting cut-off saw and includes a saw blade 210 and a saw blade guard 220. The “down-cutting” nomenclature refers to a direction 212 of saw blade 210 rotation typically used when the cut-off saw 200 is undertaking a cutting operation as further described below.

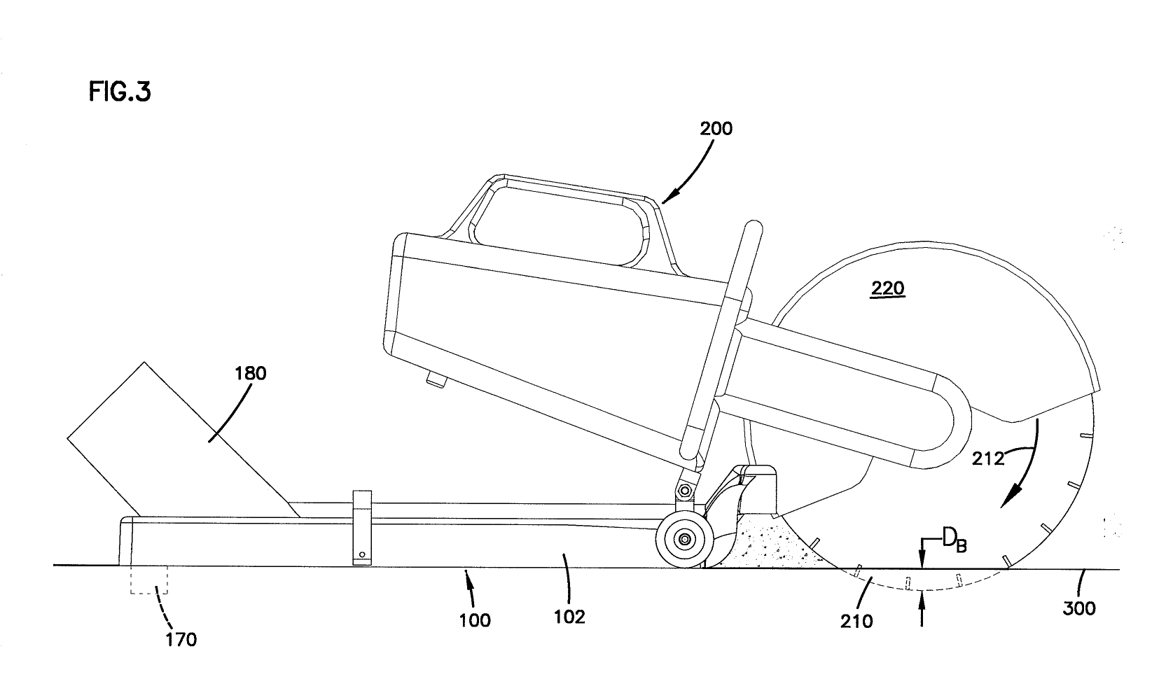

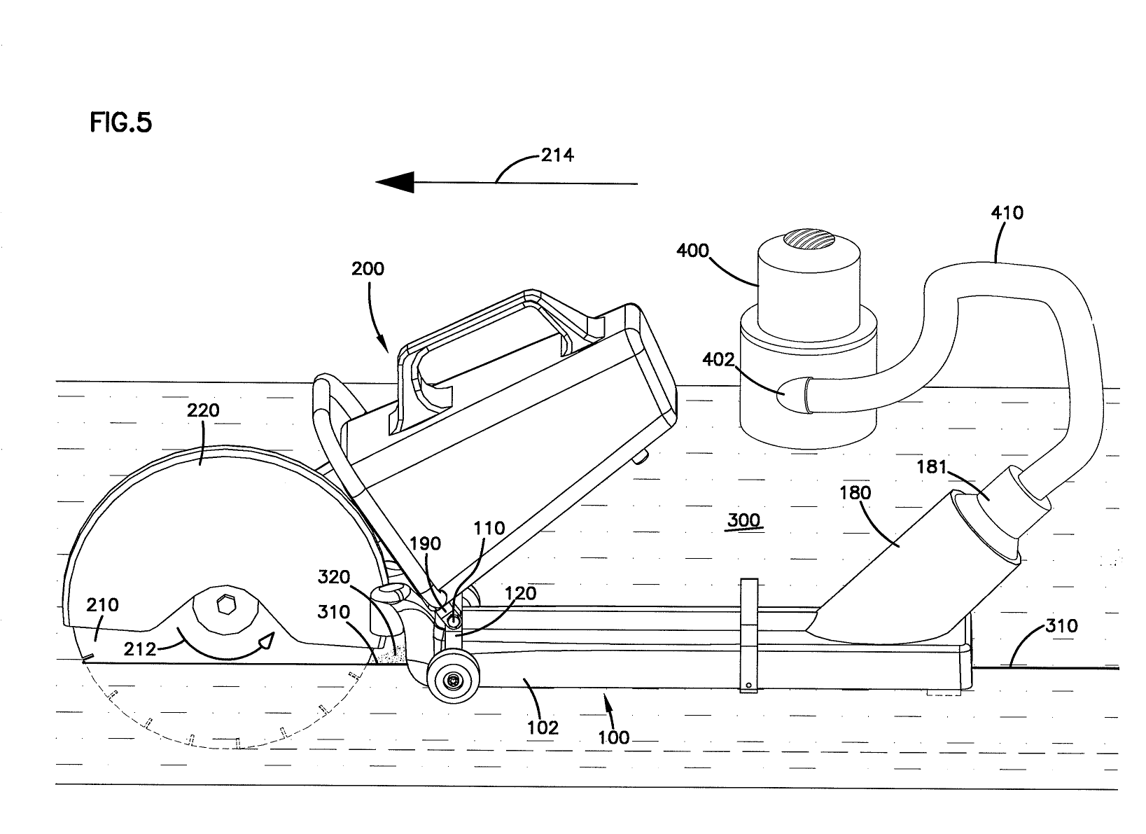

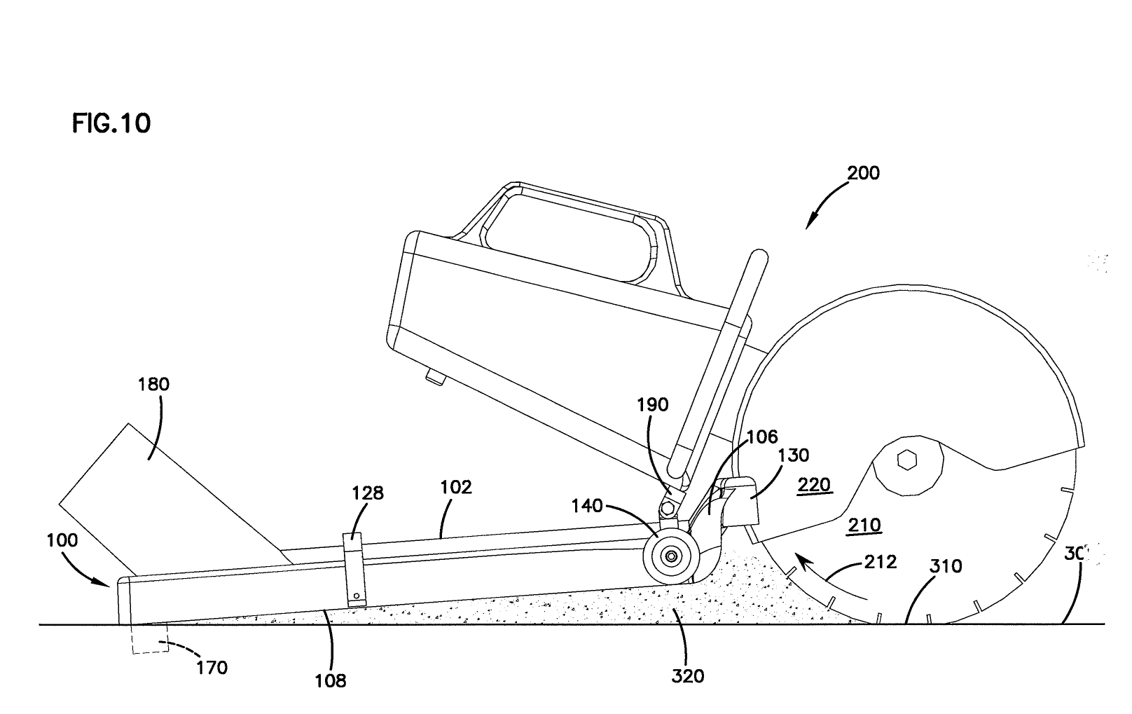

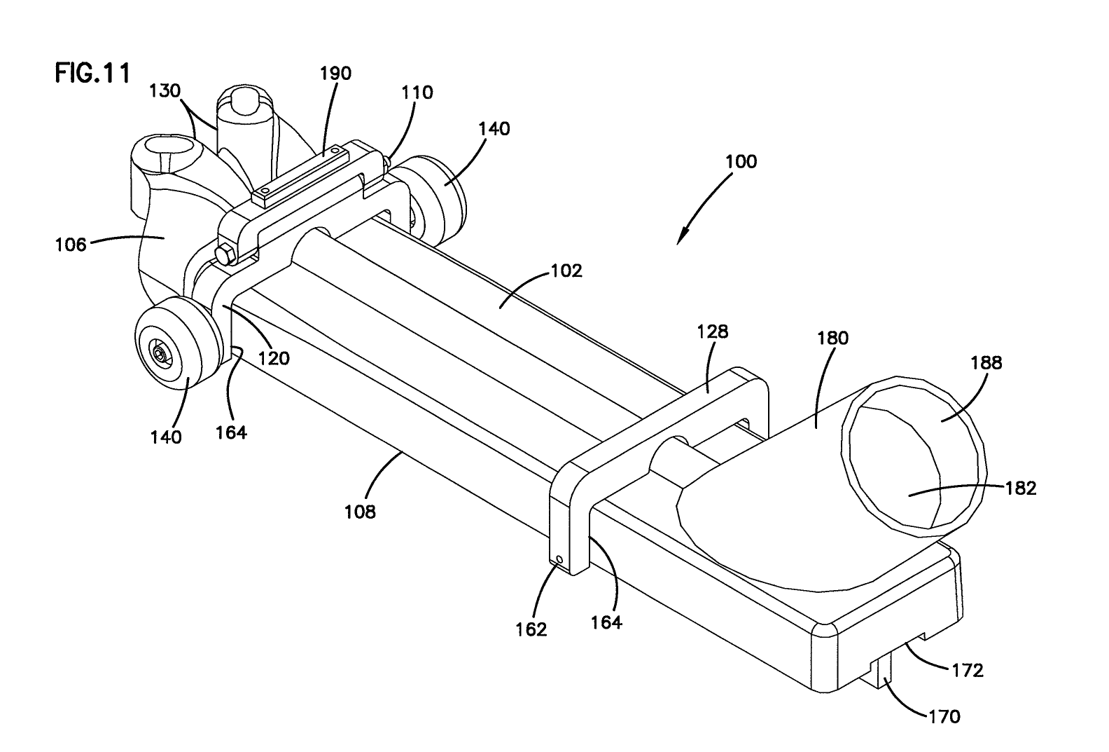

As illustrate at FIG. 10, a cut 310 can be initiated on a concrete slab 300 by positioning the cut-off saw 200 such that the saw blade 210 tangentially contacts the concrete slab 300. The rotational direction 212 and speed of the saw blade 210 erodes the cut 310 into the concrete slab 300 and ejects dust and/or debris 320 rearward. As illustrated at FIG. 3, continued operation of the cut-off saw 200 causes the saw blade 210 to penetrate the concrete slab 300 to a depth D_{B}. Upon the depth D_{B} reaching a desired depth or upon the saw blade 210 cutting through the concrete slab 300, the cut-off saw 200 can be driven in a forward direction 214 as illustrated at FIG. 5. Continued driving in the forward direction 214 results in lengthening the cut 310 and in the continued ejection of dust and/or debris 320.

The present disclosure provides a dust and debris evacuator 100 for capturing and containing most, if not all, of the dust and debris 320 generated by the operation of the cut-off saw 200. The dust and debris evacuator 100 can also provide other valuable functions such as supporting the cut-off saw 200 when in a non-cutting configuration as illustrated at FIG. 1 (the saw blade 210 is a distance H_{B} above the concrete slab 300). The dust and debris evacuator 100 has numerous embodiments and optional features, several of which are further described below and others which are arrived at by combining the various features and embodiments in different combinations.

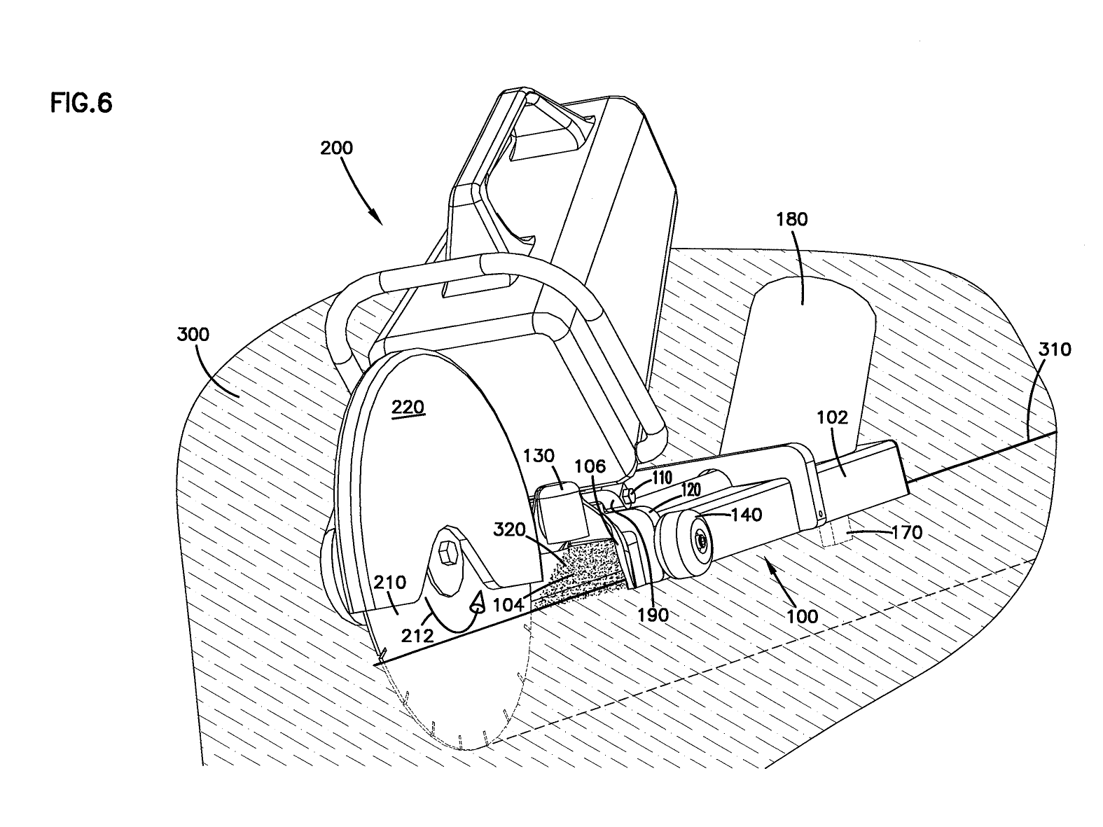

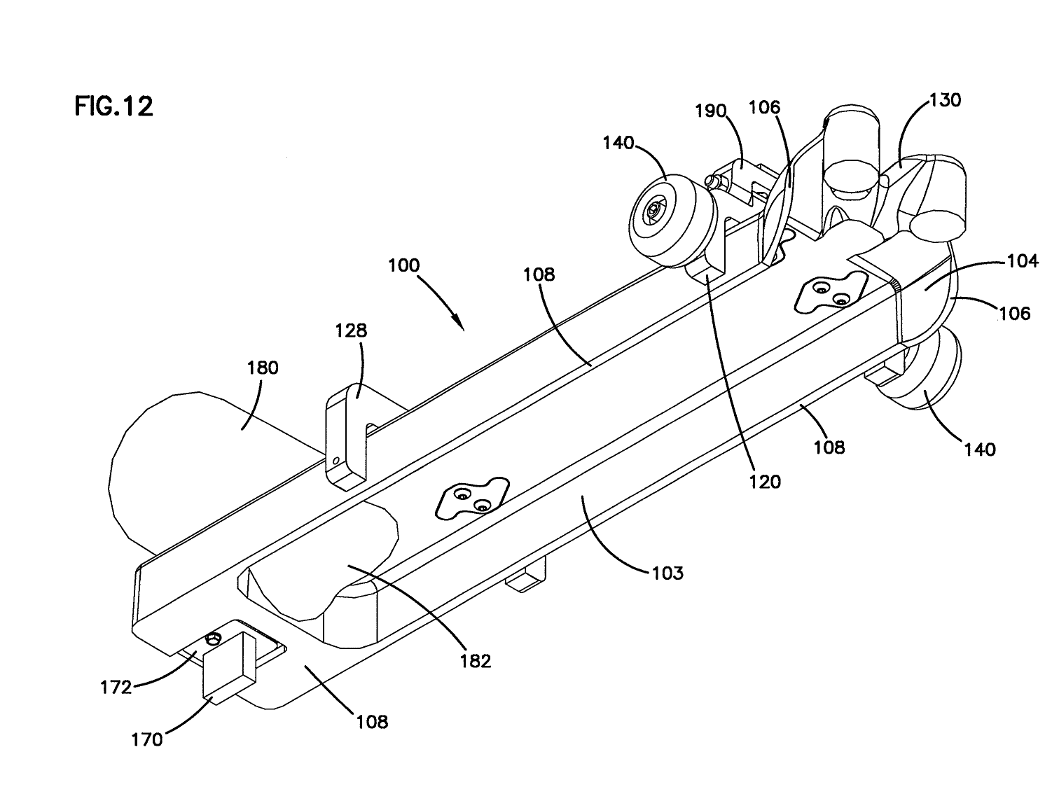

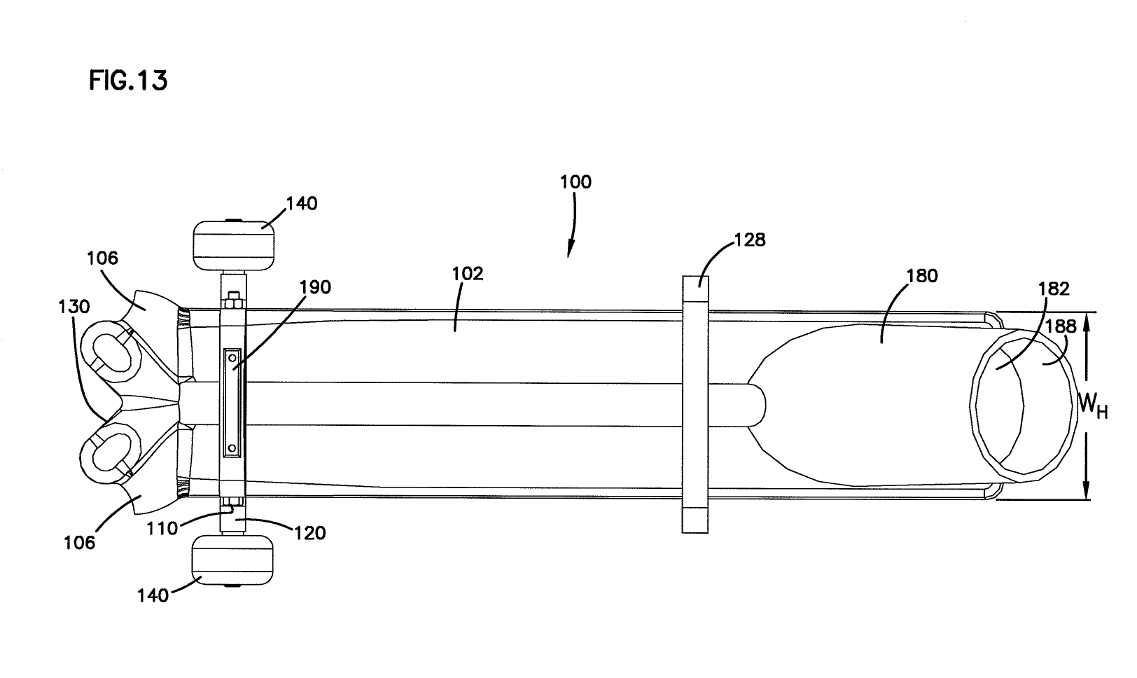

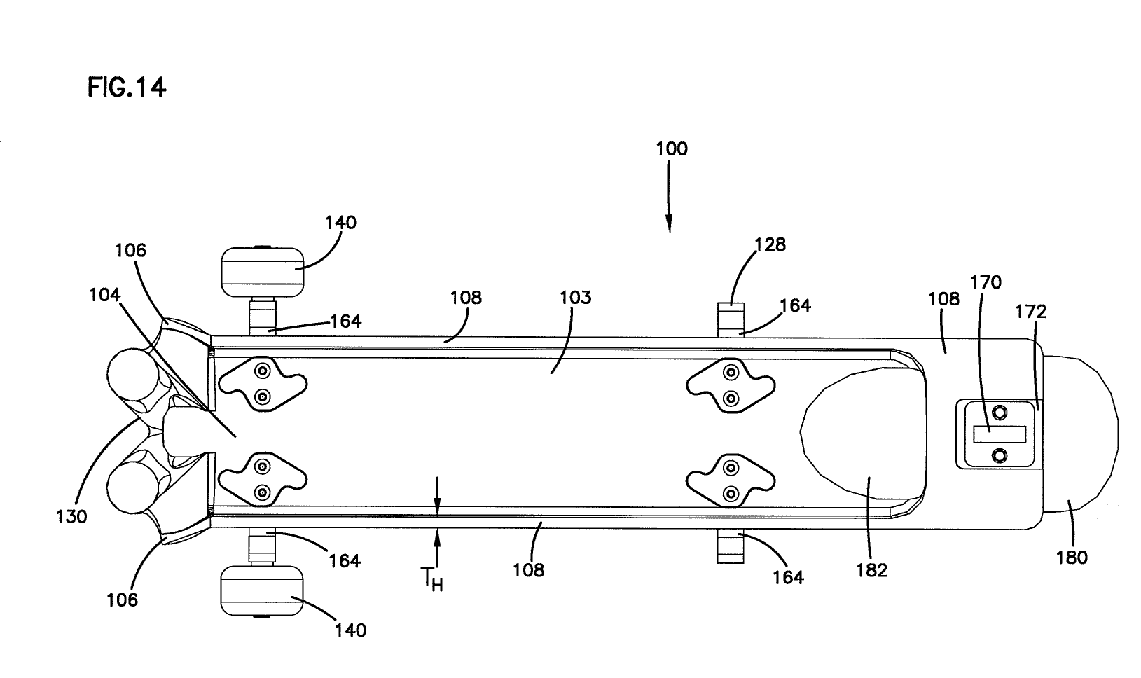

In a preferred embodiment, illustrated at FIGS. 1-10, the dust and debris evacuator 100 is positioned behind the saw blade 210 and below an internal combustion engine of the cut-off saw 200. The dust and debris evacuator 100 includes an evacuator shroud 102 extending from a forward end to a rearward end. In a preferred embodiment, the evacuator shroud 102 is molded of polyurethane. In other embodiments, the evacuator shroud 102 can be made of other materials and include multiple pieces. As illustrated at FIGS. 6 and 12, the evacuator shroud 102 includes an evacuator channel 103 that is open facing downward towards the concrete slab 300. A forward opening 104 from the channel 103 is provided at the forward end of the evacuator shroud 102. A pair of funneling flaps 106 is optionally connected to the forward opening 104. Preferably integrated with the funneling flaps 106 is a blade guard surround 130 also known as “heads”. The blade guard surround 130 closely surrounds a portion of the saw blade guard 220 and serves to keep the ejected dust and debris 320 from upwardly escaping. In a preferred embodiment, areas near an outer radius R_{G} of the saw blade guard 220 substantially seal against the blade guard surround 130. The blade guard surround 130 is preferably mounted to and/or made of a flexible material such as polyurethane to allow flexible and compliant sealing between the saw blade guard 220 and the blade guard surround 130.

The arrangement of the funneling flaps 106, the blade guard surround 130, the forward opening 104, and the channel 103 serves to effectively collect and gather the dust and debris 320 being ejected by the cut-off saw 200 both in a cut initiation configuration, illustrated at FIG. 10, and in a sustained cutting configuration, illustrated at FIGS. 5 and 6. (A cut may also be initiated in the sustained cutting configuration.) In the sustained cutting configuration, as illustrated at FIGS. 5 and 6, the channel 103 is open to and covers a portion of the cut 310 and a bottom 108 of the evacuator shroud 102 at least partially seals against the concrete slab 300. In the cut initiation configuration, the channel 103 provides a backstop to the ejected dust and debris 320. A length L_{H} of the evacuator shroud 102 provides distance for the ejected dust and debris 320 to loose momentum and be collected. In certain embodiments, the length L_{H} ranges from 1 to 8 times a radius R_{B} of the saw blade 210. In a preferred embodiment, the length L_{H} ranges from 2 to 6 times the radius R_{B} of the saw blade 210. In a more preferred embodiment, the length L_{H} ranges from 3 to 4 times the radius R_{B} of the saw blade 210. A width W_{H} of the evacuator shroud 102 provides space for the ejected dust and debris 320 to diverge from a direction tangential to the saw blade 210 and still be collected. In certain embodiments, the width W_{H} ranges from 0.2 to 2 times the radius R_{B} of the saw blade 210. In a preferred embodiment, the width W_{H} ranges from 0.5 to 1.5 times the radius R_{B} of the saw blade 210. In a more preferred embodiment, the width W_{H} ranges from 0.75 to 1.25 times the radius R_{B} of the saw blade 210.

Near the rearward end of the evacuator shroud 102 a vacuum port 180 is provided to allow a pneumatic connection between the dust and debris evacuator 100 and a suction port 402 of a vacuum cleaner 400. The vacuum port 180 includes a vacuum port passage 182 connecting the vacuum port 180 with the channel 103 and also includes one or more connection surfaces 188. A vacuum port adapter 181, 181′ and a vacuum hose 410 may additionally be used to pneumatically connect the dust and debris evacuator 100 and the vacuum cleaner 400 (see FIG. 5). Suction, generated by the vacuum cleaner 400, creates airflow, flowing toward the vacuum cleaner 400, through the vacuum hose 410, the vacuum port adapter 181 or 181′, the vacuum port passage 182, and the channel 103. The airflow along the channel 103 entrains the dust and debris 320. The entrained dust and debris 320 follow the airflow through the channel 103, the passage of the vacuum port 182, the vacuum port adapter 181 or 181′, the vacuum hose 410, and the suction port 402 into the vacuum cleaner 400. The dust and debris 320 can be collected and accumulated in the vacuum cleaner 400 and disposed of.

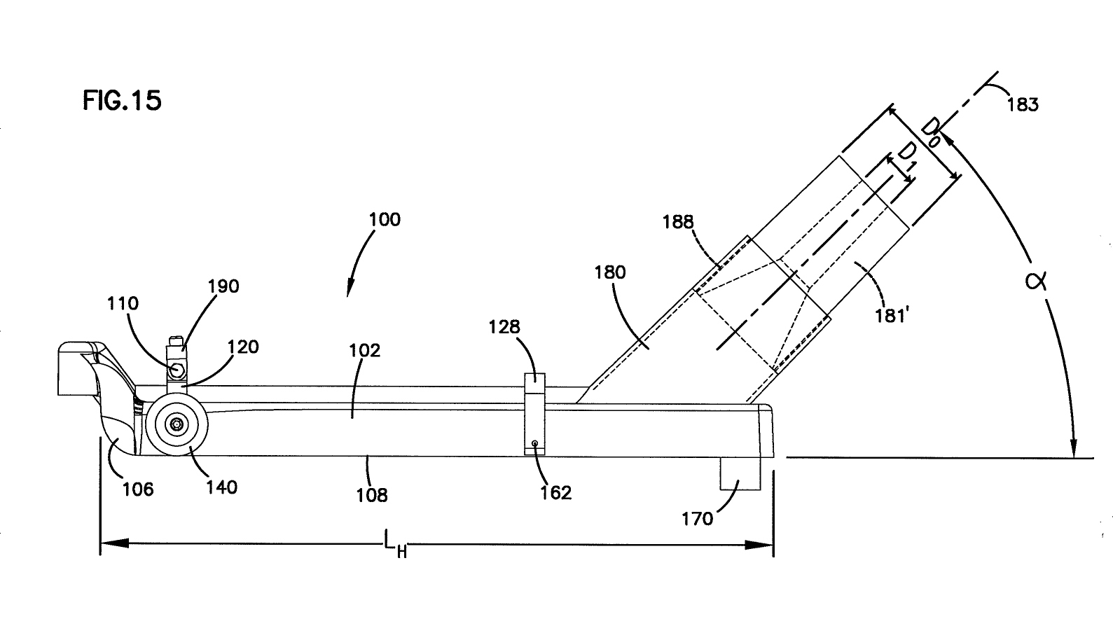

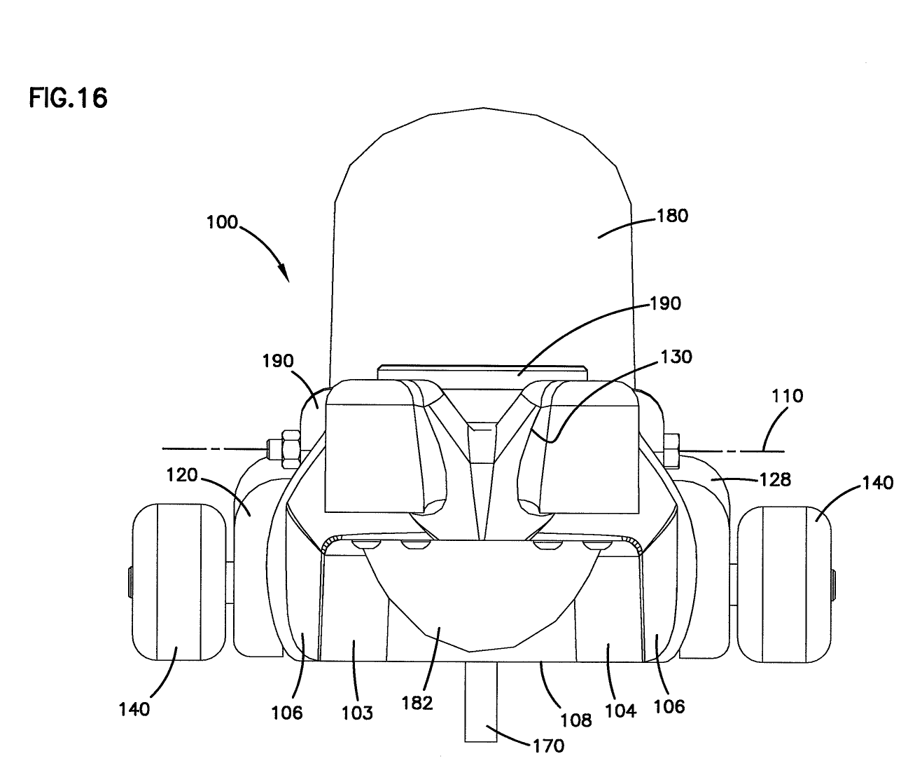

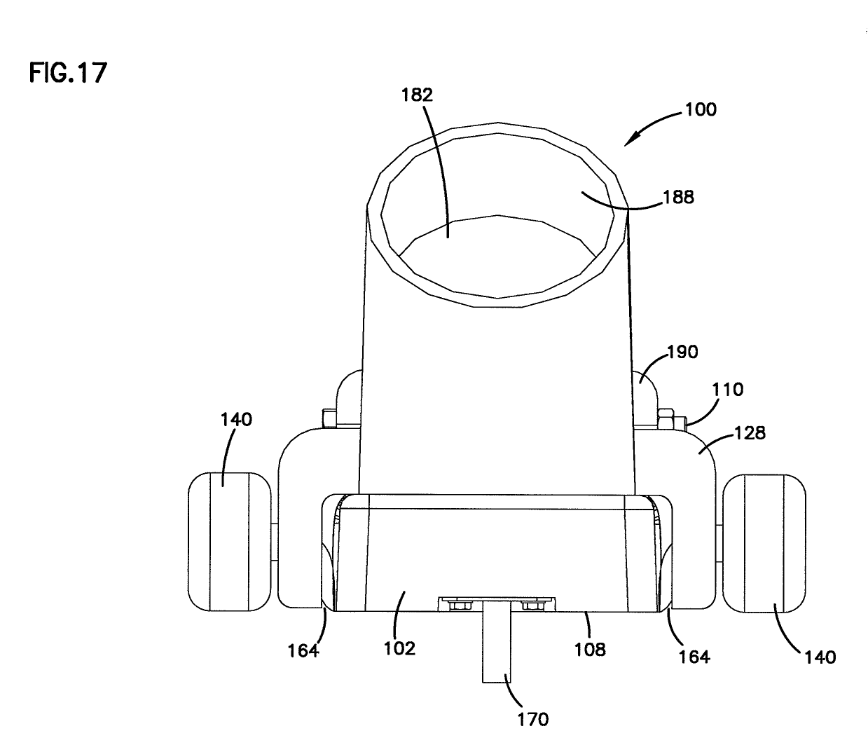

In a preferred embodiment, as illustrated at FIG. 15, the vacuum port 180, as idealized by a centerline 183, is angled at an angle α above the evacuator shroud bottom 108. The angle α promotes airflow in a direction advantageous for the entrainment and evacuation of the dust and debris 320. In certain embodiments, the angle α can range from 0 to 180 degrees. In a preferred embodiment, the angle α can range from 20 to 90 degrees. In a more preferred embodiment, the angle α can range from 30 to 60 degrees.

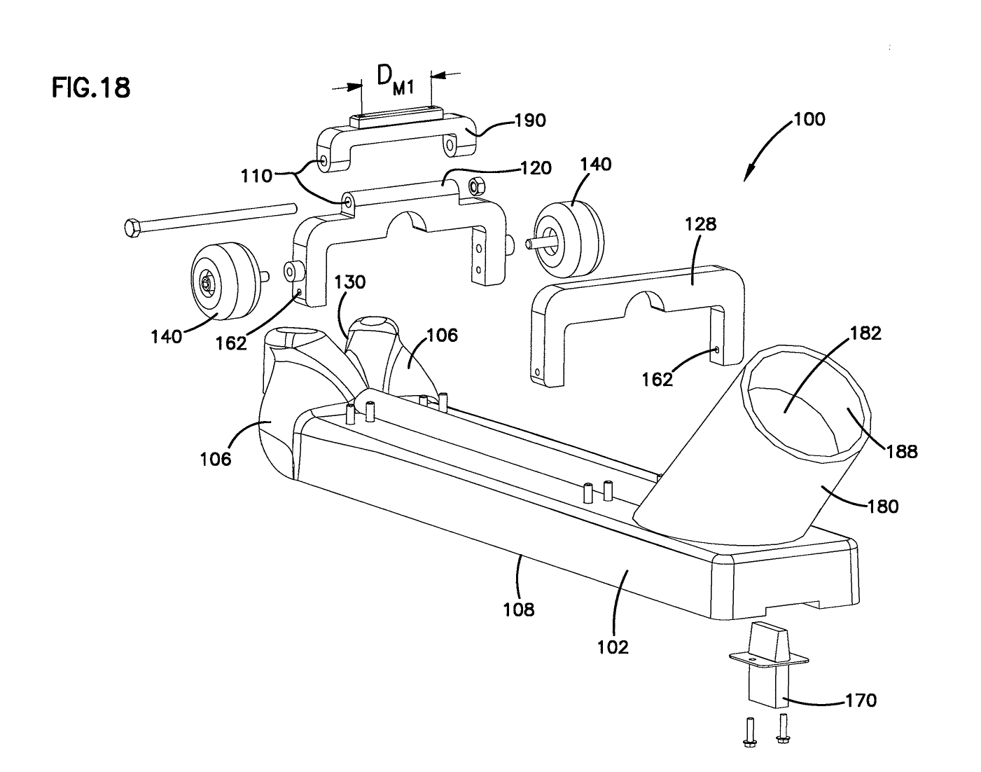

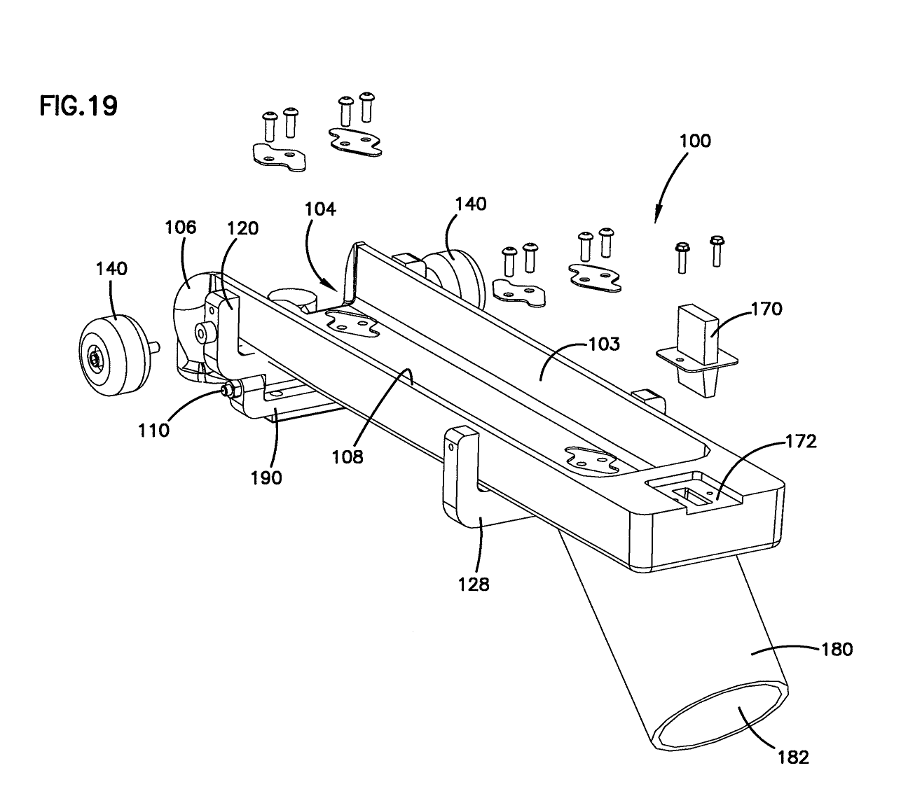

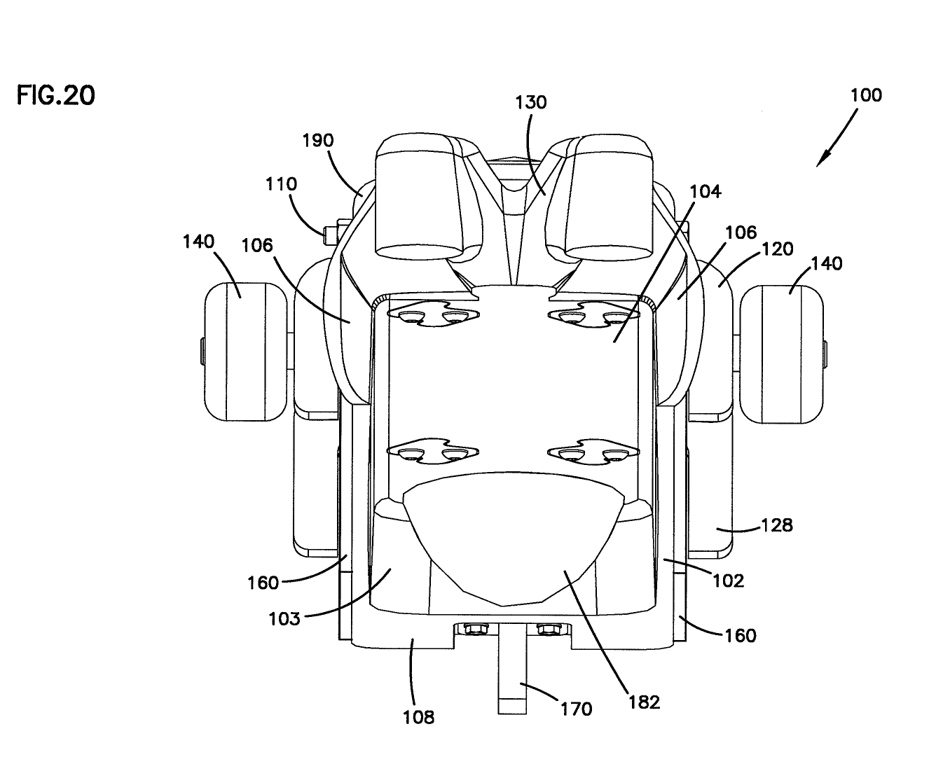

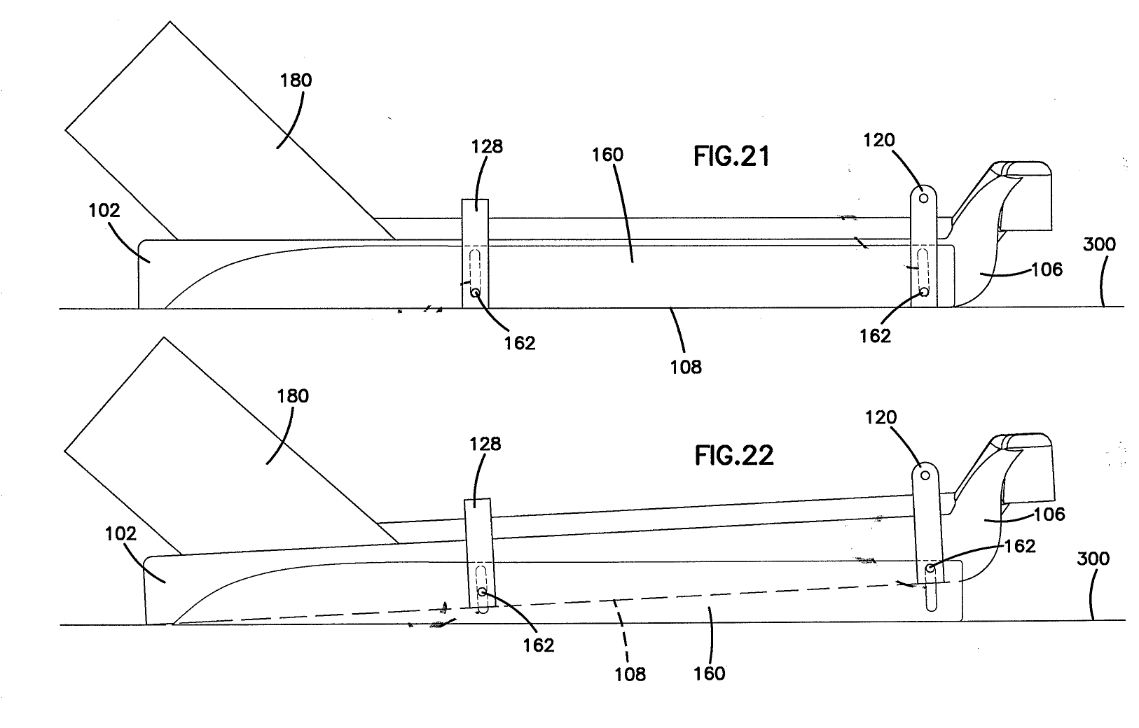

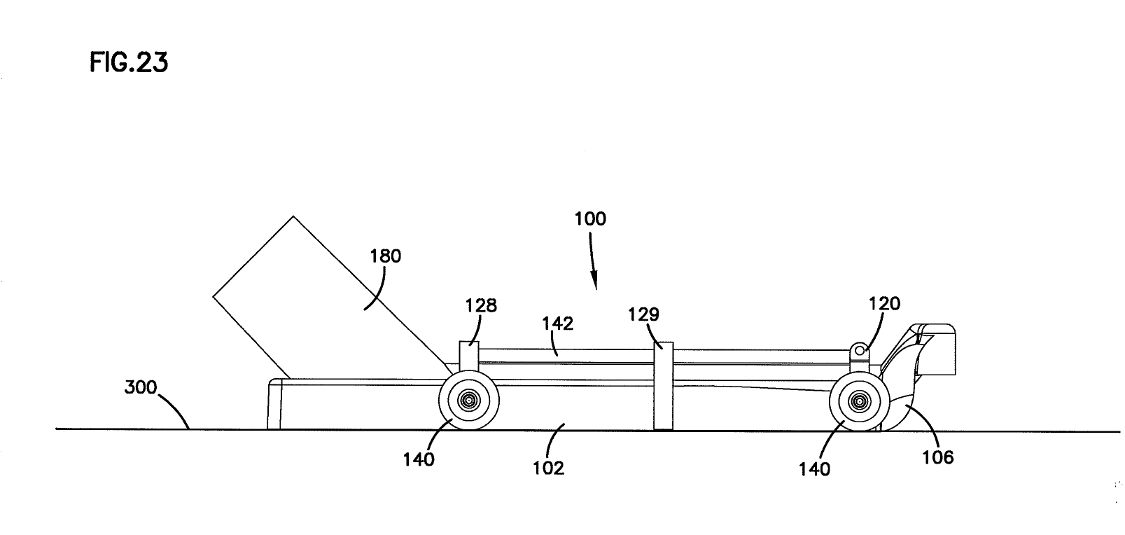

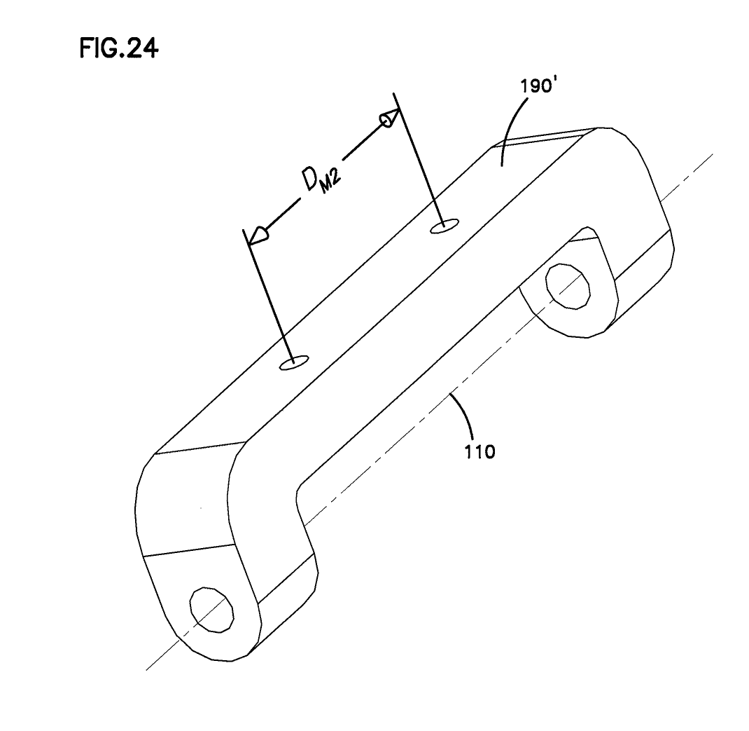

In a preferred embodiment of the present disclosure, an adaptor bracket is provided to connect to one of the example cut-off saws mentioned above and another adaptor bracket is provided to connect to another one of the example cut-off saws. Each of the adaptor brackets can individually connect to a mounting bracket of the dust and debris evacuator 100. By this method, many different models of cut-off saws may be mounted to the same model dust and debris evacuator 100. In a more preferred embodiment of the present disclosure, an integrated adaptor bracket/mounting bracket 190 (see FIG. 18) is provided to connect to one of the example cut-off saws 200 mentioned above and another integrated adaptor bracket/mounting bracket 190′ (see FIG. 24) is provided to connect to another one of the example cut-off saws. Each of the integrated adaptor bracket/mounting bracket 190, 190′ also includes a pivot mount 110 for pivotally mounting to the dust and debris evacuator 100. By this method, many different models of cut-off saws may be pivotally mounted to the same model dust and debris evacuator 100. Features that vary between the integrated adaptor bracket/mounting brackets 190 and 190′ may include, for example, the distance between cut-off saw mounting holes D_{M1} and D_{M2}.

In a preferred embodiment, the dust and debris evacuator 100 connects to the mounting bracket that is connected to the adaptor bracket that is connected to one of the example cut-off saws. In a more preferred embodiment, the dust and debris evacuator 100 includes a front support bracket with integrated pivot mount 120. The front support bracket with integrated pivot mount 120 is pivotally connected to the integrated adaptor bracket/mounting bracket 190, 190′. A pivot joint is thereby formed between the cut-off saw 200 and the dust and debris evacuator 100 as illustrated at FIGS. 1-10.

The front support bracket with integrated pivot mount 120 can further connect to a pair of wheels 140 as illustrated at FIG. 18. The front support bracket with integrated pivot mount 120 in combination with a second support bracket 128 can optionally support a pair of evacuator side shields 160.

The evacuator side shields 160 can fit within a gap 164 between the brackets 120, 128 and the sides of the dust and debris evacuator 100. Mounting holes 162 engage slots to retain the side shields 160. The side shields 160 can slide up and down thereby variably increasing and decreasing the effective depth of the evacuator channel 103.

A brush 172 is provided to fill the cut 310.

A cut-off saw used with the dust and debris evacuator 100 may be powered by pneumatics, hydraulics, or an electric motor.

Materials other than concrete may be cut by the cut-off saw and have the dust collected by the dust and debris evacuator 100.

A slurry may be evacuated by the dust and debris evacuator 100 and a wet-vac.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A dust and debris evacuator for use with a cut-off saw having a disk-shaped cutting blade ejecting dust and debris, the dust and debris evacuator comprising:
a shroud body having a first end, a second end, a top, a bottom, a right side, and a left side, the shroud body having a channel defined between the first end and the second end, the channel open to the bottom of the shroud body, the channel defining a forward opening at the first end of the shroud body; and
a vacuum port including a passage to the channel;
wherein the channel is positioned behind the disk-shaped cutting blade of the cut-off saw to receive the ejected dust and debris.

2. The dust and debris evacuator of claim 1, further comprising a blade guard surround adjacent the first end of the shroud body, the blade guard surround closely surrounding a blade guard of the cut-off saw.

3. The dust and debris evacuator of claim 1, further comprising a pivot mount adjacent the top of the shroud body for pivotally mounting the cut-off saw.

4. The dust and debris evacuator of claim 3, wherein the pivot mount is integrated with a front support bracket adjacent the first end of the shroud body and connected to the shroud body.

5. The dust and debris evacuator of claim 1, further comprising a first moveable side shield and a second moveable side shield, the first moveable side shield adjacent the right side of the shroud body and the second moveable side shield adjacent the left side of the shroud body, the first and second moveable side shields variably extending a depth of the channel.

6. The dust and debris evacuator of claim 5, wherein the first and second moveable side shields are each moveably mounted on at least one mounting slot.

7. The dust and debris evacuator of claim 6, wherein the at least one mounting slot is included within each of the first and second moveable side shields.

8. The dust and debris evacuator of claim 4, further comprising a first moveable side shield and a second moveable side shield, the first moveable side shield adjacent the right side of the shroud body and the second moveable side shield adjacent the left side of the shroud body, the first and second moveable side shields moveably mounted to the front support bracket and variably extending a depth of the channel.

9. The dust and debris evacuator of claim 8, further comprising at least one evacuator support bracket connected to the shroud body positioned rearward from the front support bracket, the first and second moveable side shields also moveably mounted to the at least one evacuator support bracket.

10. The dust and debris evacuator of claim 1, further comprising a pair of wheels adjacent the first end of the shroud body, the pair of wheels supporting the first end of the shroud body above a slab of material such that a minimal gap is formed between the bottom of the shroud body and the slab of material.

11. The dust and debris evacuator of claim 4, further comprising a pair of wheels adjacent the first end of the shroud body, the pair of wheels rotatably mounted to the front support bracket.

12. The dust and debris evacuator of claim 1, further comprising a pair of funneling flaps adjacent the forward opening of the channel.

13. The dust and debris evacuator of claim 1, further comprising a vacuum cleaner with a suction port, the suction port pneumatically connected to the vacuum port.

14. The dust and debris evacuator of claim 3, further comprising a cut-off saw adapter bracket, the cut-off saw adapter bracket adapted for mounting to a specific model cut-off saw.

15. The dust and debris evacuator of claim 14, further comprising a cut-off saw mounting bracket pivotally mounted to the pivot mount and connected to the cut-off saw adapter bracket.

16. The dust and debris evacuator of claim 14, wherein the cut-off saw adapter bracket is integrated with a cut-off saw mounting bracket, the cut-off saw mounting bracket pivotally mounted to the pivot mount.

17. The dust and debris evacuator of claim 1, further comprising an in cut dust and debris deflector brush adjacent the second end of the shroud body.

18. The dust and debris evacuator of claim 1, further comprising a framework, the framework including:
a front support bracket with an integrated pivot mount adjacent the first end of the shroud body and connected to the shroud body;
a horizontal cross bracket connected to the front support bracket and extending rearward from the front support bracket; and
at least one evacuator support bracket connected to the horizontal cross bracket and the shroud body.

19. The dust and debris evacuator of claim 18, further comprising a set of wheels including a front pair of wheels and a rear pair of wheels, the front pair of wheels adjacent the first end of the shroud body and connected to the front support bracket, the rear pair of wheels positioned rearward from the front pair of wheels and connected to one of the evacuator support bracket(s), and the set of wheels supporting the shroud body above a slab of material such that a minimal gap is formed between the bottom of the shroud body and the slab of material.

20. A dust and debris evacuator for use with a down-cutting cut-off saw having a disk-shaped cutting blade ejecting dust and debris rearward while cutting a slot-shaped cut in a slab of material, the dust and debris evacuator comprising:
a shroud body having a forward end, a rearward end, a top, a bottom, a right side, and a left side, the shroud body having a channel defined between the forward end and the rearward end, the channel open to the bottom of the shroud body, the channel defining a forward opening at the forward end of the shroud body; and
a vacuum port including a passage to the channel;
wherein the forward and bottom opening of the channel is configurable behind the disk-shaped cutting blade of the cut-off saw to receive the rearwardly ejected dust and debris, the forward end of the shroud body held a distance above the slab of material, and the rearward end of the shroud body contacting the slab of material.

21. A dust and debris evacuator for use with a down-cutting cut-off saw having a disk-shaped cutting blade ejecting dust and debris rearward while cutting a slot-shaped cut in a slab of material, the dust and debris evacuator comprising:
a shroud body having a forward end, a rearward end, a top, a bottom, a right side, and a left side, the shroud body having a channel defined between the forward end and the rearward end, the channel open to the bottom of the shroud body, the channel defining a forward opening at the forward end of the shroud body; and
a vacuum port including a passage to the channel;
wherein the forward and bottom opening of the channel is configurable behind the disk-shaped cutting blade of the cut-off saw to receive the rearwardly ejected dust and debris, the bottom of the shroud body adjacent the slab of material behind the cut-off saw.

22. A saw assembly comprising:
a cut-off saw including a drive mechanism housed at least partially within a drive mechanism housing, the cut-off saw including a blade that is driven by the drive mechanism in a down-cut direction, the blade being partially covered by a blade guard;
a dust collection housing that is elongated along a length that extends from a front end to a back end, the dust connection housing defining a dust collection channel extending along the length of the dust collection housing generally from the front end to the back end, the dust collection housing including a port for placing a source of vacuum in fluid communication with the dust collection channel, the dust collection housing also including an open bottom region at a bottom of the dust collection housing for allowing dust to be drawn upwardly into the dust collection channel, the dust collection housing further including an open front region at the front of the of the dust collection housing for allowing dust to enter the dust collection channel through the front end of the dust collection housing, the dust collection housing being pivotally connected to the drive mechanism housing at a pivot location positioned adjacent the front end of the dust collection housing, the front end of the dust collection housing being positioned adjacent the blade and the back end of the dust collection housing extending rearwardly beyond the drive mechanism housing.

23. The saw assembly of claim 22, further comprising wheels for supporting the dust collection housing on a surface being cut.

24. The saw assembly of claim 23, wherein the wheels are located generally beneath the pivot location.

25. The saw assembly of claim 22, further comprising a cut-filler carried by the dust collection housing that aligns with the blade and is adapted to fit within a cut created by the blade in a surface being cut.

26. The saw assembly of claim 22, wherein the dust collection housing includes a blade guard surround positioned at the front end of the dust collection housing, the blade guard surround straddling the blade guard, and wherein the dust collection housing also includes an upward extension for elevating the blade guard surround relative to a main body of the dust collection housing.
